(19) United States
(12) Patent Application Publication
(10) Pub. No.: US 2011/0305203 A1
(43) Pub. Date: Dec. 15, 2011

(54) WIRELESS TRANSFER APPARATUS AND WIRELESS TRANSFER METHOD

(75) Inventors: Ken MATSUSHITA, Tama-shi (JP); Hideki MIYAZATO, Yokohama-shi (JP)

(73) Assignee: KABUSHIKI KAISHA TOSHIBA, Tokyo (JP)

(21) Appl. No.: 13/216,134

(22) Filed: Aug. 23, 2011

Related U.S. Application Data
(63) Continuation of application No. 12/783,361, filed on May 19, 2010.

(30) Foreign Application Priority Data
May 19, 2009 (JP) 2009-121199

(51) Int. Cl. H04W 40/00

(52) U.S. Cl. 370/328

(57) ABSTRACT

According to one embodiment, a wireless transfer apparatus generates physical addresses by adding values, which are different between the source-side wireless transfer apparatuses, to a physical address received from a sink device, and transmits the generated physical addresses to the source-side wireless transfer apparatuses. The wireless transfer apparatus switches the source-side wireless transfer apparatus, which is to be used for transmitting content data to the sink device, to the source-side wireless transfer apparatus corresponding to the identifier which is associated with the physical address included in a source change request transmitted from the sink device.

### CROSS-REFERENCE TO RELATED APPLICATIONS

This application is a continuation of U.S. patent application Ser. No. 12/783,361, filed May 19, 2010, which is based upon and claims the benefit of priority from Japanese Patent Application No. 2009-121199, filed May 19, 2009; the entire contents of both of which are incorporated herein by reference.

### FIELD

Embodiments described herein relate generally to a wireless transfer apparatus and a wireless transfer method for executing wireless data transfer between a sink device and a plurality of source devices.

### BACKGROUND

In recent years, an interface standard such as HDMI (High-Definition Multimedia Interface) has been used as an interface for transmitting video data. The HDMI interface is used in order to transmit content data, such as a digital television signal, from a source device of any kind, such as a DVD (Digital Versatile Disc) player or a set-top box, to a sink device of any kind, such as a TV or a projector. The source device and the sink device are connected via a single cable. The content data (video data, audio data), which is output from the source device, is transmitted to the sink device via the single cable.

However, since the cable connection restricts the places of installation of the source device and sink device, it is difficult to dispose the source device and sink device at arbitrary locations.

Jpn. Pat. Appln. KOKAI Publication No. 2008-153827 discloses a wireless transmission apparatus which wirelessly connects devices. This apparatus includes a wireless interface and a wired interface. When this apparatus has received a message including a physical address via the wireless interface, the apparatus generates a message including a physical address, which is generated from its own physical address and the physical address included in the received message, and outputs this generated message to the wired interface.

However, the technique of Jpn. Pat. Appln. KOKAI Publication No. 2008-153827 presupposes that physical addresses are already allocated to the respective devices, and no consideration is given to the scheme for allocating physical addresses to devices within the system including the wireless transmission apparatus.

The wireless connection between the sink device and the source device can be realized, for example, by using a sink-side wireless transfer apparatus (sink-side wireless adapter) which is connected by wire to the sink device, and a source-side wireless transfer apparatus (source-side wireless adapter) which is connected by wire to the source device. In this case, if a physical address, which the sink-side wireless transfer apparatus has acquired from the sink device, is transferred directly to the source-side wireless transfer apparatus, the source device can acquire the physical address from the source-side wireless transfer apparatus.

However, in such an environment that there are a plurality of source-side wireless transfer apparatuses which are connected by wire to a plurality of source devices, if the sink-side wireless transfer apparatus transfers the physical address, which has been acquired from the sink device, directly to each source-side wireless transfer apparatus, the same physical address is allocated to the respective source devices. As a result, since the source devices cannot be handled as individual devices, it becomes difficult to normally execute, for example, a routing control for switching an active source device from among the source devices. The active source device is a source device which transmits content data to the sink device.

Therefore, it is necessary to realize a novel function which can normally execute wireless data transfer between a plurality of source devices and a sink device.

### BRIEF DESCRIPTION OF THE DRAWINGS

FIG. 1 is an exemplary block diagram showing a structure example of a system including a sink device and a source device which are connected over a cable;

FIG. 2 is an exemplary block diagram showing a structure example of a system including a sink-side wireless transfer apparatus which is connected by wire to a sink device, and a source-side wireless transfer apparatus which is connected by wire to a source device;

FIG. 3 is an exemplary block diagram showing a structure example of a system including a wireless transfer apparatus according to an embodiment;

FIG. 4 is an exemplary block diagram showing a structure example of the wireless transfer apparatus according to the embodiment;

FIG. 5 is an exemplary block diagram showing another structure example of the system including the wireless transfer apparatus according to the embodiment;

FIG. 6 is an exemplary block diagram showing still another structure example of the system including the wireless transfer apparatus according to the embodiment;

FIG. 7 is an exemplary block diagram showing structure examples of a sink-side wireless transfer apparatus and a source-side transfer apparatus according to the embodiment; and

FIG. 8 is an exemplary view for explaining a physical address change process which is executed by the wireless transfer apparatus according to the embodiment.

### DETAILED DESCRIPTION

In general, according to one embodiment, a wireless transfer apparatus comprises: a wired communication interface configured to communicate with a sink device; a wireless communication interface configured to wirelessly communicate with a plurality of source-side wireless transfer apparatuses wired-connected to a plurality of source devices; a physical address generating module configured to generate a plurality of physical addresses by adding values, which are different between the source-side wireless transfer apparatuses, to a physical address received from the sink device via the wired communication interface, and to transmit the generated physical addresses to the source-side wireless transfer apparatuses via the wireless communication interface; a physical address storing module configured to store the generated physical addresses in association with identifiers of the source-side wireless transfer apparatuses; and a routing control module configured to switch the source-side wireless transfer apparatus, which is to be used for transmitting content data to the sink device, to the source-side wireless transfer apparatus corresponding to the identifier which is associated with the physical address included in a source change request transmitted from the sink device.

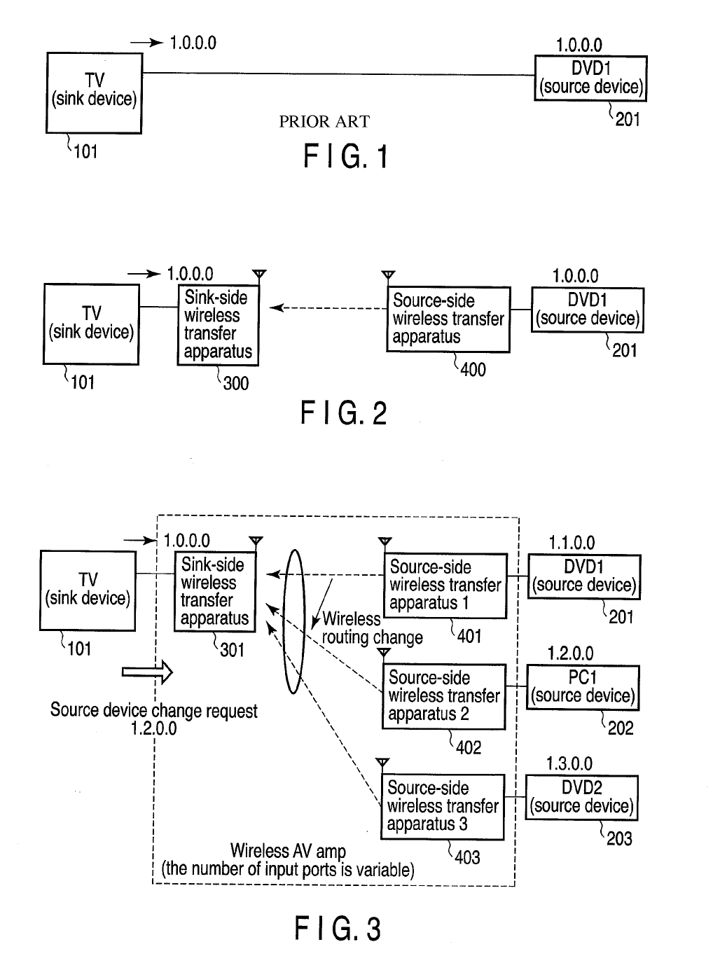

To begin with, referring to FIG. 1, a description is given of a structure example of an ordinary system in which a sink device and a source device are connected over a cable. For example, if a TV and a DVD player are connected by using an HDMI cable, high-quality video can be enjoyed. In FIG. 1, an HDMI input port of a sink device 101 and an HDMI output port of a source device 201 are connected via a cable (HDMI cable). The sink device 101 is a reception device having one or more HDMI input ports. For example, a display apparatus, such as a TV or a projector, can function as the sink device 101. The source device 201 is a transmission device having an HDMI output port. For example, a video output device of any kind, such as a DVD player or a personal computer, can function as the source device 201. The source device 201 reads out data within the sink device, which is called EDID (Enhanced Extended Display Identification Data), via a cable, thus being able to determine the capability of the sink device 101. The EDID is identification information which is indicative of the capability of the sink device 101. The EDID includes a physical address which is to be allocated to the device that is connected to the HDMI input port of the sink device 101. With the physical address being acquired by the source device 201, an HDMI network comprising devices, to which physical addresses are allocated, can be constructed. Usually, in the HDMI network, unique physical addresses are allocated to respective devices. The physical address is information for uniquely identifying the position of each device on the network topology. The physical address is used, for example, for routing control for switching an active source device which transmits content data to the sink device 101.

The physical address of the sink device 101, which is a route device, is “0.0.0.0”. The sink device 101 adds a port number of the HDMI input port to its own physical address, thereby generating a physical address “1.0.0.0” which is to be allocated to the device that is connected to the HDMI input port, and setting the generated physical address in the EDID. The EDID is prepared for each of HDMI input ports. If the sink device 101 has two HDMI input ports, two EDIDs corresponding to the two HDMI input ports are prepared in the sink device 101. The sink device 101 sets a physical address “1.0.0.0” in the EDID corresponding to a first HDMI input port. In addition, the sink device 101 sets a physical address “2.0.0.0” in the EDID corresponding to a second HDMI input port. If the source device 201 is connected to the first HDMI input port of the sink device 101 over a cable, the source device 201 reads the EDID corresponding to the first HDMI input port of the sink device 101, thus being able to acquire the physical address “1.0.0.0” as its own physical address.

In the meantime, in recent years, with the development of wireless technologies, high-quality video data having a large amount of information can be transmitted by a radio signal. FIG. 2 shows an example of the system configuration for wireless implementation of an HDMI cable.

In FIG. 2, a sink-side wireless transfer apparatus 300 is wired-connected to a first HDMI input port of a sink device 101 via an HDMI cable, and a source-side wireless transfer apparatus 400 is wired-connected to an HDMI output port of a source device 201 via an HDMI cable. Communication between the sink-side wireless transfer apparatus 300 and source-side wireless transfer apparatus 400 can be executed by wireless signals. Each of the sink-side wireless transfer apparatus 300 and source-side wireless transfer apparatus 400 has a function of converting a received wired signal to a wireless signal and transmitting the wireless signal, and a function of converting a received wireless signal to a wired signal and transmitting the wired signal. Accordingly, each of the sink-side wireless transfer apparatus 300 and source-side wireless transfer apparatus 400 can function as a wireless adapter for executing a wireless relay function (forwarding function).

The source-side wireless transfer apparatus 400 receives content data and other various control request data which are sent from the source device 201, and transfers the received content data and control request data directly to the sink-side wireless transfer apparatus 300. The sink-side wireless transfer apparatus 300 receives the content data and control request data, which are wirelessly transmitted from the source-side wireless transfer apparatus 400, and transfers the received content data and control request data directly to the sink device 101.

The sink-side wireless transfer apparatus 300 receives various control data from the sink device 101, and transfers the received control data directly to the source-side wireless transfer apparatus 400. Similarly, the source-side wireless transfer apparatus 400 receives the control data from the sink device 101, which is transferred by the sink-side wireless transfer apparatus 300, and transfers the received data directly to the source device 201.

For example, a read request (EDID read request), which is output from the source device 201, is transmitted to the sink device 101 via the source-side wireless transfer apparatus 400 and sink-side wireless transfer apparatus 300. EDID data, which is read from the sink device 101, is transmitted to the source device 201 via the sink-side wireless transfer apparatus 300 and source-side wireless transfer apparatus 400. Thus, simply by outputting the read request (EDID read request), the source device 201 can acquire its own physical address from the sink device 101.

Therefore, the wireless relay function (forwarding function) of each of the sink-side wireless transfer apparatus 300 and source-side wireless transfer apparatus 400 can realize wireless implementation of an HDMI cable for connecting the sink device 101 and source device 201, without adding any improvement to the sink device 101 and source device 201.

However, if a new pair comprising a source-side wireless transfer apparatus and a source device (for instance, a second DVD player and a source-side wireless transfer apparatus which is wired-connected to the second DVD player) is added to the system shown in FIG. 2, such a configuration of one-to-two correspondence is constituted that two source-side wireless transfer apparatuses are present in relation to one sink-side wireless transfer apparatus 300. In this case, the same EDID data is sent to two source-side wireless transfer apparatuses by the forwarding function of the sink-side wireless transfer apparatus 300. As a result, the same physical address may possibly be allocated to two source devices. In such a case, the network-topological position of each source device cannot be discriminated, and routing control, etc. may not correctly be executed.

To cope with this problem, the present embodiment provides a wireless transfer apparatus (sink-side wireless transfer apparatus) which can transmit different physical addresses to a plurality of source-side wireless transfer apparatuses which are wired-connected to a plurality of source devices. According to this wireless transfer apparatus (sink-side wireless transfer apparatus), even in the environment that there are a plurality of source-side wireless transfer apparatuses which are wired-connected to a plurality of source devices, different physical addresses for identifying positions within the HDMI network of the plural source devices can be allocated to the plural source devices.

FIG. 3 shows a structure example of a system using a wireless transfer apparatus according to an embodiment of the present invention. The wireless transfer apparatus of this embodiment is described with reference to FIG. 3. In FIG. 3, a sink-side wireless transfer apparatus 301 corresponds to the wireless transfer apparatus of the present embodiment.

The sink-side wireless transfer apparatus 301 is wired-connected to an HDMI input port of a sink device 101 via an HDMI cable. The sink device 101 is a display device such as a TV. A source-side wireless transfer apparatus 401 is wired-connected to an HDMI output port of a source device 201 via an HDMI cable. The source device 201 is, for instance, a DVD player. A source-side wireless transfer apparatus 402 is wired-connected to an HDMI output port of a source device 202 via an HDMI cable. The source device 202 is, for instance, a personal computer (PC). A source-side wireless transfer apparatus 403 is wired-connected to an HDMI output port of a source device 203 via an HDMI cable. The source device 203 is, for instance, a second DVD player.

Each of the sink-side wireless transfer apparatus 301 and source-side wireless transfer apparatuses 401, 402 and 403 has the above-described wireless relay function (forwarding function). The sink-side wireless transfer apparatus 301 selects an arbitrary one of the source-side wireless transfer apparatuses 401, 402 and 403 as the source-side wireless transfer apparatus that is the object of transfer, and can transfer to the HDMI input port of the sink device 101 the content data that is wirelessly transmitted from the selected source-side wireless transfer apparatus. In addition, the sink-side wireless transfer apparatus 301 has a physical address control function for wirelessly transmitting different physical addresses to the source-side wireless transfer apparatuses 401, 402 and 403. Furthermore, the sink-side wireless transfer apparatus 301 has a routing change function for switching the source-side wireless transfer apparatus which is the object of transfer, that is, the source-side wireless transfer apparatus which is used for transmitting content data to the sink device.

The physical address control function is used in order to allocate unique physical addresses to the individual source devices 201, 202 and 203. The sink-side wireless transfer apparatus 301 changes the value of a physical address, which is received from the sink device 101, to different values for the respective source-side wireless transfer apparatuses 401, 402 and 403, and wirelessly transmits the different physical addresses to the source-side wireless transfer apparatuses 401, 402 and 403. Specifically, the sink-side wireless transfer apparatus 301 adds values, which are different between the respective source-side wireless transfer apparatuses 401, 402 and 403, to the physical address, for instance, “1.0.0.0”, which is received from the sink device 101, thereby generating three physical addresses, for instance, “1.1.0.0”, “1.2.0.0”, and “1.3.0.0”. The sink-side wireless transfer apparatus 301 wirelessly transmits the three physical addresses “1.1.0.0”, “1.2.0.0” and “1.3.0.0” to the source-side wireless transfer apparatuses 401, 402 and 403.

The source device 201 can acquire the physical address “1.1.0.0” as its own physical address from the source-side wireless transfer apparatus 401. Similarly, the source device 202 can acquire the physical address “1.2.0.0” as its own physical address from the source-side wireless transfer apparatus 402, and the source device 203 can acquire the physical address “1.3.0.0” as its own physical address from the source-side wireless transfer apparatus 403.

In the sink-side wireless transfer apparatus 301, the generated three physical addresses “1.1.0.0”, “1.2.0.0” and “1.3.0.0” are stored in an address table within the sink-side wireless transfer apparatus 301 in the state in which the three physical addresses “1.1.0.0”, “1.2.0.0” and “1.3.0.0” are associated with the identifiers (station IDs) of the source-side wireless transfer apparatuses 401, 402 and 403.

Various timings are usable as the timing for generating physical addresses and the timing for transmitting the generated physical addresses to the source-side wireless transfer apparatuses. For example, the physical addresses can be generated by a trigger of the reception of an EDID read request from the source device.

For example, if the source device 201 outputs an EDID read request, the EDID read request is wirelessly transmitted by the source-side wireless transfer apparatus 401 to the sink-side wireless transfer apparatus 301. When the sink-side wireless transfer apparatus 301 has received the EDID read request from the source-side wireless transfer apparatus 401, the sink-side wireless transfer apparatus 301 reads the EDID data of the sink device 101, thereby acquiring the physical address from the sink device 101. The sink-side wireless transfer apparatus 301 adds an arbitrary value to the physical address, thereby generating one physical address and wirelessly transmitting this physical address to the source-side wireless transfer apparatus 401 that has sent the EDID read request. The generated physical address, together with the identifier of the source-side wireless transfer apparatus 401, is stored in the address table. Thereafter, when the sink-side wireless transfer apparatus 301 has received an EDID read request from another source-side wireless transfer apparatus, for instance, the source-side wireless transfer apparatus 402, the sink-side wireless transfer apparatus 301 reads the EDID data of the sink device 101, thereby acquiring once again the physical address from the sink device 101. The sink-side wireless transfer apparatus 301 refers to the address table, thereby generating a physical address with a value different from the value of the already generated physical address. This generated physical address is wirelessly transmitted to the source-side wireless transfer apparatus 402 that has sent the EDID read request, and is stored, together with the identifier of the source-side wireless transfer apparatus 402, in the address table.

Next, the routing change function is described.

A source change request, which is transmitted from the sink device 101, includes a physical address for designating an active source device. The sink-side wireless transfer apparatus 301 acquires from the address table the identifier corresponding to the physical address in the source change request, and executes switching of the source-side wireless transfer apparatus corresponding to the acquired identifier to the source-side wireless transfer apparatus that is the object of transfer. Specifically, the sink-side wireless transfer apparatus 301 selects the source-side wireless transfer apparatus corresponding to the acquired identifier as the source-side wireless transfer apparatus that is the object of transfer, and transfers the content data, which is wirelessly transmitted from the selected source-side wireless transfer apparatus, to the HDMI input port of the sink device 101. Thereby, the source device, which is used for streaming of content data to the sink device 101, can be switched to the source device which is wired-connected to the source-side wireless transfer apparatus which has been selected as the source-side wireless transfer apparatus that is the object of transfer.

The physical address control function and routing change function of the sink-side wireless transfer apparatus 301 enable the sink-side wireless transfer apparatus 301 and the source-side wireless transfer apparatuses 401, 402 and 403 as a virtual wireless AV amplifier. The number of source-side wireless transfer apparatuses, which are wirelessly connectable to the sink-side wireless transfer apparatus 301, is not limited to three, and an arbitrary number of source-side wireless transfer apparatuses can be wirelessly connected to the sink-side wireless transfer apparatus 301. Accordingly, the number of input ports of the virtual wireless AV amplifier is variable.

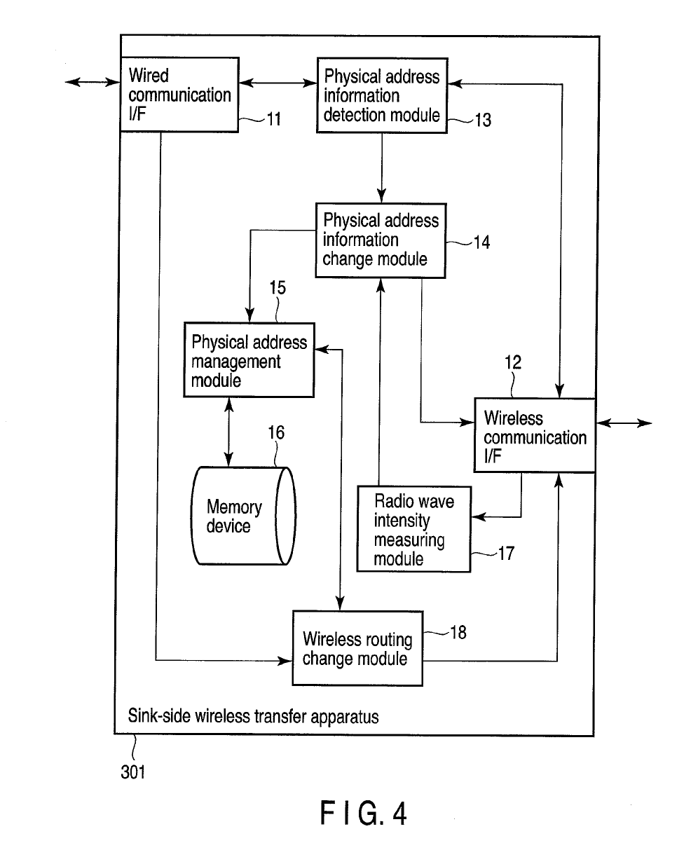

Next, referring to FIG. 4, the structure of the sink-side wireless transfer apparatus 301 is described.

The sink-side wireless transfer apparatus 301 comprises a wired communication interface 11, a wireless communication interface 12, a physical address information detection module 13, a physical address information change module 14, a physical address information management module 15, a memory device 16, a radio field intensity measuring module 17 and a wireless routing change module 18.

The wired communication interface 11 executes communication with the sink device 101 via a cable. The wireless communication interface 12 executes wireless communication with each of the source-side wireless transfer apparatus 401, 402 and 403. The data transfer between the wired communication interface 11 and wireless communication interface 12 is controlled by a controller including the physical address information detection module 13, physical address information change module 14, physical address information management module 15, memory device 16, radio field intensity measuring module 17 and wireless routing change module 18.

The physical address information detection module 13 detects a physical address included in information which is acquired from the sink device 101 via the wired communication interface 11. The physical address information change module 14 generates a plurality of physical addresses by adding values, which are different between the source-side wireless transfer apparatuses 401, 402 and 403, to the detected physical address, and wirelessly transmits the generated physical addresses to the source-side wireless transfer apparatus 401, 402 and 403. The physical address information management module 15 stores the generated physical addresses in an address table within the memory device in the state in which the physical addresses are associated with the identifiers of the source-side wireless transfer apparatuses 401, 402 and 403. The wireless routing change module 18 acquires from the address table the identifier corresponding to the physical address which is included in a source change request which is transmitted from the sink device 101, and switches the source-side wireless transfer apparatus, which is the object of content data transfer, to the source-side wireless transfer apparatus corresponding to the acquired identifier. Specifically, the wireless routing change module 18 executes a content data transfer control for transferring to the sink device 101 the content data which is wirelessly transmitted from the source-side wireless transfer apparatus corresponding to the acquired identifier.

Next, a description is given of the respective process procedures of the internal process which is executed in the sink-side wireless transfer apparatus 301.

(1) The sink-side wireless transfer apparatus 301 includes, as basic functions, a function of wirelessly transmitting data, which is input from the wired communication interface 11 that is connected to the sink device 101, to each of the source-side wireless transfer apparatus 401, 402 and 403 via the wireless communication interface 12, and a function of transmitting data, which is wirelessly transmitted from each of the source-side wireless transfer apparatus 401, 402 and 403, to the sink device 101 via the wired communication interface 11.

One of the data, which are transferred between the sink device and the source device, is EDID. In order for each of the source devices 201, 202 and 203 to determine the details of a video output signal thereof, each source device, 201, 202, 203, needs to read data called “EDID”, which is possessed by the sink device 101. The EDID includes information indicative of, e.g. the display capability of the sink device 101, and the physical address which is to be allocated to the source device that is connected to the sink device 101. If a certain source device outputs an EDID read request, the EDID read request is wirelessly transmitted to the sink-side wireless transfer apparatus 301 from the source-side wireless transfer apparatus that is connected to this source device. Responding to the reception of the EDID read request that is wirelessly transmitted from the source-side wireless transfer apparatus, the sink-side wireless transfer apparatus 301 reads the EDID data of the sink device 101 via the wired communication interface 11, and returns the read EDID data via the wireless communication interface 12 to the source-side wireless transfer apparatus that is the source of the request of the EDID data.

(2) The physical address information detection module 13 detects a physical address from the information which is acquired from the sink device 101 and is the object of transfer. In the case where the information that is the object of transfer is the EDID data, the physical address information detection module 13 detects the physical address in the EDID data, and instructs the physical address information change module 14 to change the value of the detected physical address.

(3) The physical address information change module 14 changes the value of the physical address in the EDID data, and wirelessly transmits the EDID data including the changed physical address to the source-side wireless transfer apparatus, which is the source of the request of the EDID data, via the wireless communication interface 12. The change of the value of the physical address is executed so as to generate different physical addresses in association with source-side wireless transfer apparatuses, from which the request for the EDID data is sent. Specifically, the physical address information change module 14 generates different physical addresses for the respective source-side wireless transfer apparatuses by adding values, which are different between the respective source-side wireless transfer apparatuses, to the physical address which is detected by the physical address information detection module 13. For example, the physical address is changed such that the digit next to the effective digit (last effective digit) in a pre-change physical address is varied between the respective source-side wireless transfer apparatuses. The physical address is expressed by an address that is 4 digits long, and each digit comprises four bits. For example, in the case where a pre-change physical address is “1.0.0.0”, the digit (the second digit in this example) next to the last effective digit (the digit that is not “0”) of the physical address may be varied between the respective source-side wireless transfer apparatuses. The values of changed physical addresses become “1.1.0.0”, “1.2.0.0” and “1.3.0.0”. Specifically, the physical address information change module 14 replaces the value of the physical address in the read EDID data with a value which is obtained by adding to the value of this physical address a value corresponding to the source-side wireless transfer apparatus which has sent the EDID read request, and the physical address information change module 14 wirelessly transmits the EDID data, which includes the changed physical address, to the source-side wireless transfer apparatus, which is the source of the request of the EDID data, via the wireless communication interface 12.

In order to avoid an overlap of values of physical addresses which are sent to a plurality of source-side wireless transfer apparatuses, the physical address information change module 14 delivers a pair of the identifier (station ID) of the source-side wireless transfer apparatus, which is the source of the request of the EDID data, and the value of the changed physical address to the physical address information management module 15.

(4) The physical address information management module 15 stores in the address table in the memory device 16 the respective changed physical addresses in association with corresponding station IDs. By virtue of the address table, each source-side wireless transfer apparatus, which is represented by the station ID, can be associated with the physical address at any time.

By the process so far, different physical addresses are allocated to the respective source devices, as shown in FIG. 3. Each source device broadcasts its own physical address to all the other devices. Thus, the sink device 101 can recognize the physical addresses of all source devices.

(5) The sink device 101 can transmit a source change request, for example, by using a control protocol which is called HDMI-CEC, thereby to change the source device which sends content data to the sink device 101. The source change request includes a physical address which is indicative of a source device which is to be selected by switching, that is, a physical address which is indicative of a source device which is to be selected as a new active source device.

(6) The wireless routing change module 18 analyzes a control command from the sink device 101, which is input to the wired communication interface 11, and determines whether this control command is a source change request or not. In the case where the control command is a source change request, the wireless routing change module 18 acquires the station ID corresponding to the physical address which is included in the source change request. Further, the wireless routing change module 18 transmits to the wireless communication interface 12 an instruction to switch the source-side wireless transfer apparatus, which is the object of transfer, to the source-side wireless transfer apparatus corresponding to the acquired station ID. Then, the wireless routing change module 18 transfers the content data, which is wirelessly transmitted from the source-side wireless transfer apparatus corresponding to the acquired station ID, to the sink device 101 via the wired communication interface 11. The source change request is also transmitted to the source-side wireless transfer apparatus corresponding to the acquired station ID via the wireless communication interface 12. Needless to say, the source change request may be transmitted to all source-side wireless transfer apparatuses.

As has been described above, in the present embodiment, the sink-side wireless transfer apparatus 301 generates a plurality of different physical addresses corresponding to a plurality of source-side wireless transfer apparatuses, and transmits the generated physical addresses to the respective source-side wireless transfer apparatuses. In addition, the sink-side wireless transfer apparatus 301 manages the generated physical addresses by associating them with the identifiers of the source-side wireless transfer apparatuses. Therefore, different physical addresses can be allocated to all source devices, and the HDMI network can be made to function normally.

The sink-side wireless transfer apparatus 301 may be configured to acquire the physical address from the sink device 101 when the sink-side wireless transfer apparatus 301 is connected by wire to the sink device 101, and to generate, by using this physical address, a plurality of physical addresses. The number of physical addresses corresponds to the number of source-side wireless transfer apparatuses wirelessly connected to the sink-side wireless transfer apparatus 301.

Next, another embodiment is described.

A description is given of the respective process procedures of the internal process which is executed in the sink-side wireless transfer apparatus 301.

(1) When a certain source device has output an EDID read request, the source-side wireless transfer apparatus, which is connected to the source device, wirelessly transmits the EDID read request to the sink-side wireless transfer apparatus 301. The sink-side wireless transfer apparatus 301 reads the EDID data of the sink device 101 via the wired communication interface 11.

(2) The physical address information detection module 13 detects the physical address in the EDID data that has been read, and instructs the physical address information change module 14 to change the value of the detected physical address.

(3) The radio wave intensity measuring module 17 cooperates with the wireless communication interface 12 and measures the radio wave intensity of the radio signal which is sent from each of the source-side wireless transfer apparatus 401, 402 and 403. Thereby, the present wireless communication environment is recognizable with respect to each of the source-side wireless transfer apparatuses, and the stability of transmission of content data is understood. For the user, it is more advantageous to use, as an active source device, a source device which is connected to a source-side wireless transfer apparatus with a higher radio wave intensity.

(4) The physical address information change module 14 changes the value of the physical address in the EDID data, and wirelessly transmits the EDID data including the changed physical address to the source-side wireless transfer apparatus, which is the source of the request of the EDID data, via the wireless communication interface 12. The change of the value of the physical address is executed so as to generate different physical addresses in association with source-side wireless transfer apparatuses, from which the request for the EDID data is sent. Specifically, the physical address information change module 14 generates different physical addresses for the respective source-side wireless transfer apparatuses by adding values, which are different between the respective source-side wireless transfer apparatuses, to the physical address which is detected by the physical address information detection module 13. For example, the physical address is changed such that the digit next to the effective digit in a pre-change physical address is varied between the respective source-side wireless transfer apparatuses. The physical address information change module 14 acquires the radio wave intensity information of each source-side wireless transfer apparatus from the radio wave intensity measuring module 17, and changes the value in such an order that a lowest physical address is allocated to a highest radio wave intensity. Specifically, the physical address information change module 14 changes, on the basis of the measurement result of the radio wave intensity by the radio wave intensity measuring module 17, the values, which are to be added to the pre-change physical address acquired from the sink device 101, in association with the respective source-side wireless transfer apparatuses, in such a manner that a lowest physical address is allocated to the source-side wireless transfer apparatus with a highest radio wave intensity of all the plural source-side transfer apparatuses. The higher the radio wave intensity of the source-side wireless transfer apparatus, the lower the value that is to be added to the pre-change physical address. For example, assume the case in which the radio wave intensity of the source-side transfer apparatus 401 is highest, the radio wave intensity of the source-side transfer apparatus 403 is second highest and the radio wave intensity of the source-side transfer apparatus 402 is lowest. In the case where the pre-change physical address is “1.0.0.0”, physical addresses “1.1.0.0”, “1.3.0.0” and “1.2.0.0” are allocated to the source-side wireless transfer apparatus 401, 402 and 403. The physical address information change module 14 delivers a pair of the identifier (station ID) of the source-side wireless transfer apparatus, which is the source of the request of the EDID data, and the value of the changed physical address to the physical address information management module 15. At this time, in the case where the radio wave intensity is lower than a predetermined value and stable transmission/reception cannot be expected, the physical address information change module 14 can execute such an address change as to allocate a physical address “F.F.F.F”, which is indicative of “disable”, to the associated source device. The source device, which has acquired the EDID data including “F.F.F.F”, can be excluded from the network.

(5) The physical address information management module 15 stores in the address table in the memory device 16 the respective changed physical addresses in association with corresponding station IDs. By virtue of the address table, each source-side wireless transfer apparatus, which is represented by the station ID, can be associated with the physical address at any time.

By the process so far, different physical addresses are allocated to the respective source devices, as shown in FIG. 3.

(6) Each source device broadcasts its own physical address to all the other devices. Specifically, each source device transmits to the sink device the physical address which is allocated to itself, and a control command for declaring that this source device is connected to the network. For this purpose, for example, use is made of a control protocol which is called HDMI-CEC. The sink device 101 acquires physical address information of each source device from the above-described command which has been sent from each source device, and can construct a GUI menu, or the like, which prompts the user to instruct switching of the active source device. In many cases, a connection device information list, which is displayed on the GUI menu, displays physical addresses in an ascending order (an order from the lowest one). Thus, if a lower physical address is allocated to a high radio wave intensity, such an advantage can be expected that source devices are listed up in the order of radio wave intensity as candidate source devices to which the active source device is to be changed.

(7) The sink device 101 can transmit a source change request, for example, by using a control protocol which is called HDMI-CEC, thereby to change the source device which sends content data to the sink device 101. The source change request includes a physical address which is indicative of a source device which is to be selected by switching, that is, a physical address which is indicative of a source device which is to be selected as a new active source device.

(8) The wireless routing change module 18 analyzes a control command from the sink device 101, which is input to the wired communication interface 11, and determines whether this control command is a source change request or not. In the case where the control command is a source change request, the wireless routing change module 18 acquires the station ID corresponding to the physical address which is included in the source change request. Further, the wireless routing change module 18 transmits to the wireless communication interface 12 an instruction to switch the source-side wireless transfer apparatus, which is the object of transfer, to the source-side wireless transfer apparatus corresponding to the acquired station ID. Then, the wireless routing change module 18 transfers the content data, which is wirelessly transmitted from the source-side wireless transfer apparatus corresponding to the acquired station ID, to the sink device 101 via the wired communication interface 11. The source change request is also transmitted to the source-side wireless transfer apparatus corresponding to the acquired station ID via the wireless communication interface 12. Needless to say, the source change request may be transmitted to all source-side wireless transfer apparatuses.

By the above-described process, different physical addresses can be allocated to all source devices, and the HDMI network can be made to function normally.

Next, still another embodiment is described.

In the preceding embodiments, the description has been given of the physical address management in the case where the source-side wireless transfer apparatus has only one wired connection interface, and the one-to-one relationship between the source-side wireless transfer apparatus and the source device is ensured.

In the present embodiment, it is assumed that the source-side wireless transfer apparatus has a plurality of HDMI input ports, and different physical addresses are allocated to source devices which are connected by cable to the respective HDMI input ports.

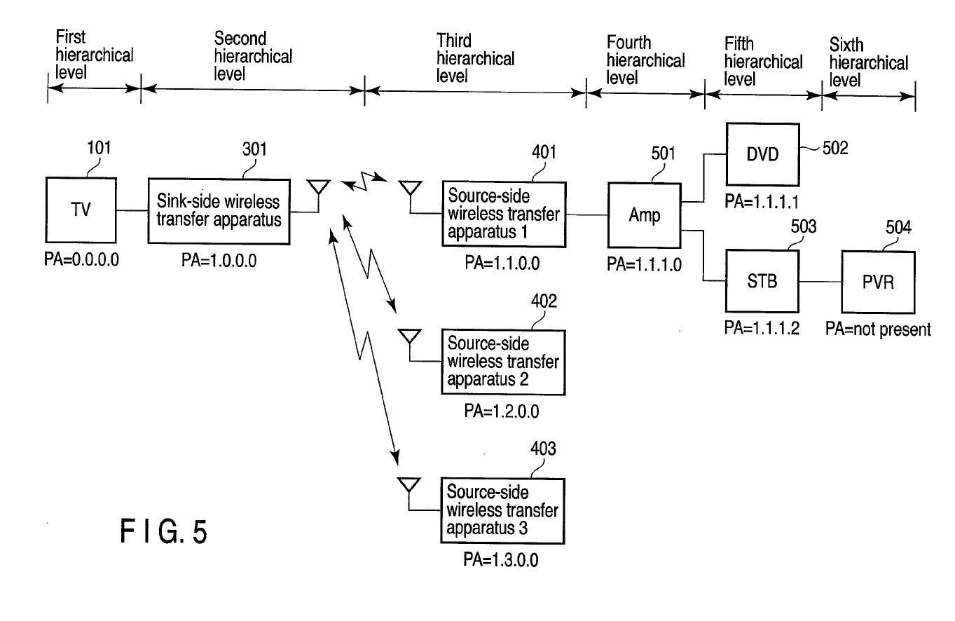

FIG. 5 is a view illustrating allocation of physical addresses (“PA” hereinafter and in the Figures) to respective devices in an HDMI network. The PA is expressed by a 4-digit address, and each digit comprises four bits. Usually, the physical address of a TV which is a root device is “0.0.0.0”. A sink device, or a Repeater device, generates PAs which are to be allocated to devices in lower hierarchical levels. The effective digit of the value of the generated PA is displaced by one digit as the hierarchical level lowers by one. The generated PA is stored in the EDID in the sink device or Repeater device. Each device can acquire its own PA by reading the EDID of a device of a higher hierarchical level via a DDC (Display Data Channel).

However, since the PA is expressed by four digits, only a 5-level-deep hierarchy can necessarily be managed. The following hierarchical connection, as shown in FIG. 5, is now assumed: sink device 101—sink-side wireless transfer device 301—source-side wireless transfer apparatus 401—amplifier (AMP) 501—set-top box (STB) 503—personal video recorder (PVR) 504. In this case, PAs are correctly allocated up to the STB 503 in the fifth hierarchical level, but no PA can be allocated to the PVR 504 in the sixth hierarchical level. The reason for this is that two hierarchical levels are used by the sink-side wireless transfer device 301 and source-side wireless transfer apparatuses 401 to 403.

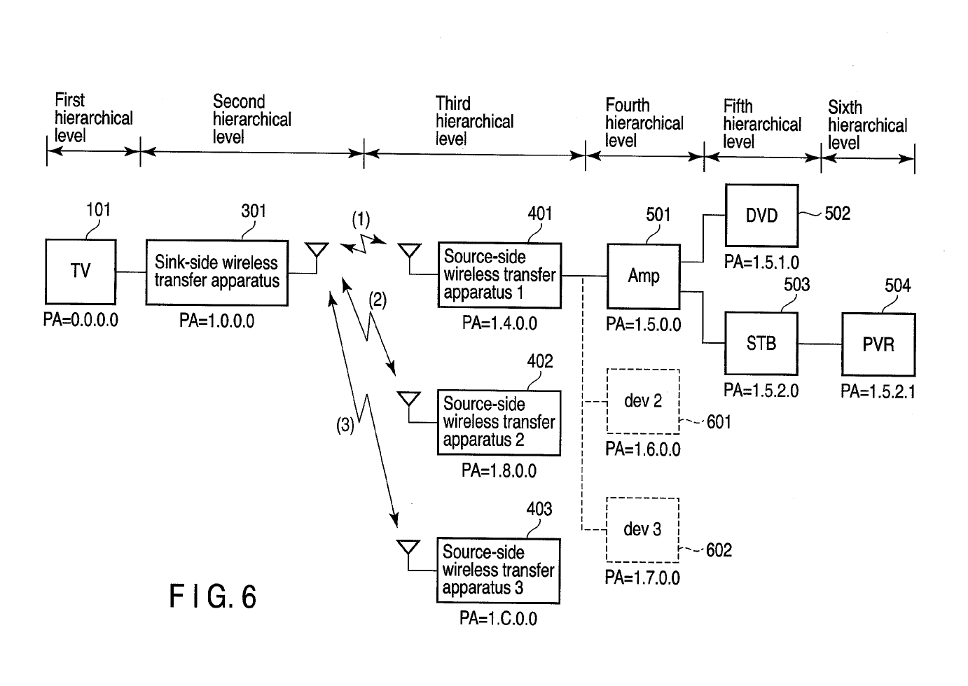

FIG. 6 is a view illustrating the allocation of PAs in the present embodiment.

This PA allocation makes it possible to correctly allocate a PA to the PVR 504 in the sixth hierarchical level, even in the system to which the same device connection method as in FIG. 5 is applied. A description is given of the structure for realizing this PA allocation.

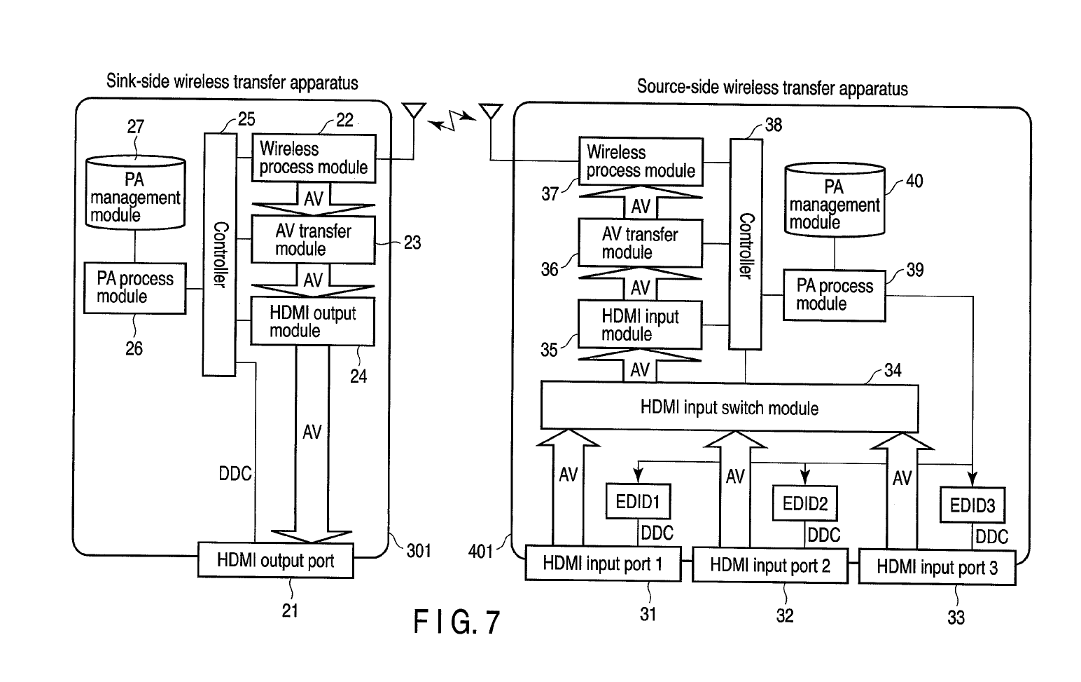

FIG. 7 shows the structures of the sink-side wireless transfer device 301 and source-side wireless transfer apparatus 401 shown in FIG. 6. The other source-side wireless transfer apparatuses 402 and 403 shown in FIG. 6 have the same structure as the source-side wireless transfer apparatus 401.

The sink-side wireless transfer device 301 comprises an HDMI output port 21, a wireless process module 22, an AV (audio-video) transfer module 23, an HDMI output module 24, a controller 25, a PA process module 26 and a PA management module 27.

The HDMI output port 21 and wireless process module 22 correspond to the wired communication interface 11 and wireless communication interface 12 shown in FIG. 4, respectively. Content data (AV data), which has been received by the wireless process module 22, is sent to the HDMI input port of the sink device 101 via the AV transfer module 23, HDMI output module 24 and HDMI output port 21. The controller 25 corresponds to the physical address information detection module 13, radio wave intensity measuring module 17 and wireless routing change module 18 shown in FIG. 4. The controller 25 controls the transfer of content data to the sink device 101, and the transfer of various control data between the sink device 101 and each source-side wireless transfer apparatus. The controller 25 can read from the sink device 101 data, such as EDID data, via a signal line in an HDMI cable, which is called “display data channel (DDC)”.

The PA process module 26 has the same function as the physical address information change module 14 shown in FIG. 4. The PA process module 26 further includes a PA process function for realizing the PA allocation as illustrated in FIG. 6. Specifically, the PA process module 26 generates different physical addresses corresponding to the respective source-side wireless transfer apparatuses by adding values, which are different between the respective source-side wireless transfer apparatuses, to an upper bit portion of the four bits which represents the digit next to the effective digit (last effective digit) of the physical address acquired from the sink device 101. In this manner, by generating the physical addresses corresponding to the source-side wireless transfer apparatuses by using only the upper bit portion of the four bits of the digit next to the effective digit, it is possible to use the lower bit portion of the four bits of the digit next to the effective digit, as an address region for allocating physical addresses to the source devices connected to the respective source-side wireless transfer apparatuses.

The PA management module 27, like the address table described with reference to FIG. 4, stores the physical addresses, which are allocated to the respective source-side wireless transfer apparatuses, in association with the identifiers such as station IDs.

The source-side wireless transfer apparatus 401 includes a plurality of HDMI input ports 31, 32 and 33. In addition, in order to support a plurality of source devices which are connected to the HDMI input ports 31, 32 and 33, the source-side wireless transfer apparatus 401 also includes an HDMI input switch module 34, an HDMI input module 35, an AV transfer module 36, a wireless process module 37, a controller 38, a PA process module 39 and a PA management module 40.

The HDMI input switch module 34 functions as a switch. In order to switch the active source device, the HDMI input switch module 34 selects content data (AV data) which is input from an arbitrary one of the HDMI input ports 31, 32 and 33. The HDMI input module 35, AV transfer module 36 and wireless process module 37 are used in order to wirelessly transfer the content data from an arbitrary source device to the sink-side wireless transfer apparatus 301. The controller 38 controls the transfer of content data from the source device to the sink-side wireless transfer apparatus 301, and the transfer of various control data between each source device and the sink-side wireless transfer apparatus 301. The PA process module 39 cooperates with the PA management module 40, and generates physical addresses which are to be allocated to the source devices that are connected to the HDMI input ports 31, 32 and 33.

Next, a description is given of the PA process which is executed by the sink-side wireless transfer apparatus 301.

The HDMI output port 21 of the sink-side wireless transfer apparatus 301 is connected to the HDMI input port of the sink device 101 via the HDMI cable. The controller 25 of the sink-side wireless transfer apparatus 301 enables the sink-side wireless transfer apparatus 301 to detect the sink device 101. For this detection, for example, use may be made of a hot-plug detection signal from the sink device 101. When the hot-plug detection signal becomes active, the controller 25 reads the EDID data of the sink device 101, thereby acquiring its own physical address “1.0.0.0” from the sink device 101.

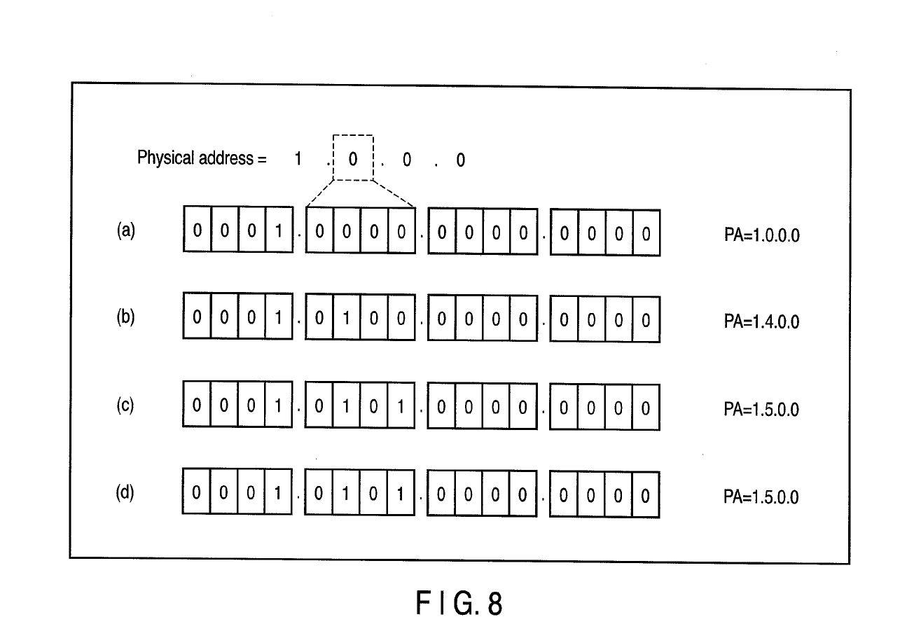

In the system configuration shown in FIG. 6, the sink-side wireless transfer apparatus 301 can function as a Repeater device. In this case, the sink-side wireless transfer apparatus 301 needs to allocate PAs to devices in the lower hierarchical levels thereof. The PA process module 26 of the sink-side wireless transfer apparatus 301 uses PA=1.0.0.0 ((a) in FIG. 8) which is allocated to the sink-side wireless transfer apparatus 301, and generates some PAs for the lower hierarchical levels. At this time, the necessary number of PAs to be generated is the number of source-side wireless transfer apparatuses which are wirelessly connected to the sink-side wireless transfer apparatus 301. In the generation of PAs, the PA process module 26 generates some PAs of different values by adding values, which are different between the source-side wireless transfer apparatuses, to only the upper 2-bit portion of the four bits of the second digit of the PA (=1.0.0.0).

Specifically, the PA process module 26 does not fully use the four bits of the second digit of the PA (=1.0.0.0). The PA process module 26 first generates PA=1.4.0.0 ((b) in FIG. 8) by using only two MSB-side bits of the four bits of the second digit of PA (=1.0.0.0). PA (=1.4.0.0) is generated by adding 0x4 (=0b0100) to the second digit of the pre-change physical address “1.0.0.0”. The symbol “0x” means a hexadecimal form. The symbol “0b” means binary data. The physical address “1.4.0.0” is used as a physical address which is to be allocated to the source-side wireless transfer apparatus 401.

Similarly, the PA process module 26 generates PA=1.8.0.0 and PA=1.C.0.0 by using only the two MSB-side bits of the four bits of the second digit of PA (=1.0.0.0). PA “1.8.0.0” is generated by adding 0x8 (=0b1000) to the second digit of the pre-change physical address “1.0.0.0”. The physical address “1.8.0.0” is used as a physical address which is to be allocated to the source-side wireless transfer apparatus 402. PA “1.C.0.0” is generated by adding 0xC (=0b1100) to the second digit of the pre-change physical address “1.0.0.0”. The physical address “1.C.0.0” is used as a physical address which is to be allocated to the source-side wireless transfer apparatus 403.

As has been described above, the physical addresses, which are to be allocated to the respective source-side wireless transfer apparatuses, are generated by changing only the value of the two upper bits of the four bits of the second digit in association with the source-side wireless transfer apparatuses. Thereby, each source-side wireless transfer apparatus can freely use the two lower bits of the four bits of the second digit of its own physical address. In other words, the sink-side wireless transfer apparatus 301 generates the physical addresses of the respective source-side wireless transfer apparatuses by using only the two upper bits of the four bits of the second digit of its own physical address. Thereby, it becomes possible to leave an address area which each source-side wireless transfer apparatus can use in order to allocate different physical addresses to a plurality of devices that are connected to its own plural input ports.

The PA management module 27 stores the physical addresses, which are generated by the PA process module 26, in the address table in association with the identifiers (e.g. station IDs, MAC addresses) of the respective source-side wireless transfer apparatuses 401, 402 and 403. After the generated physical addresses are stored in the address table, the controller 25 executes a process of transmitting the generated physical address (=1.4.0.0) to the source-side wireless transfer apparatus 401 via the wireless process module 22. Further, the controller 25 transmits the generated physical address (=1.8.0.0) to the source-side wireless transfer apparatus 402 via the wireless process module 22, and transmits the generated physical address (=1.C.0.0) to the source-side wireless transfer apparatus 403 via the wireless process module 22.

The source-side wireless transfer apparatus 401 shown in FIG. 7 receives the physical address “1.4.0.0” which is wirelessly transmitted from the sink-side wireless transfer apparatus 301. The PA process module 39 of the source-side wireless transfer apparatus 401 stores the received physical address “1.4.0.0” in the address table in the PA management module 40 as the physical address of its own device. Since the source-side wireless transfer apparatus 401 is also a Repeater device, the source-side wireless transfer apparatus 401 needs to allocate PAs to devices in lower hierarchical levels.

The PA process module 39 of the source-side wireless transfer apparatus 401 generates three physical addresses corresponding to the HDMI input ports 31, 32 and 33, by using the two LSB-side bits of the four bits of the second digit that is the last effective digit of its own physical address “1.4.0.0”. In this case, the three physical addresses are generated by adding values, which are different between the HDMI input ports, to the two lower bits of the four bits of the second digit that is the last effective digit of its own physical address “1.4.0.0”. Specifically, by the two LSB-side bits, port addresses corresponding to the HDMI input ports 31, 32 and 33 are generated. The port address of the HDMI input port 31 is 0x1, the port address of the HDMI input port 32 is 0x2, and the port address of the HDMI input port 33 is 0x3.

The PA process module 39 generates a physical address “1.5.0.0” ((c) in FIG. 8) of the HDMI input port 31, a physical address “1.6.0.0” of the HDMI input port 32 and a physical address “1.7.0.0” of the HDMI input port 33, by adding port addresses of the HDMI input ports to the second digit of its own physical address “1.4.0.0”, that is, by performing an OR arithmetic operation (logical sum arithmetic operation) between the second digit of the physical address “1.4.0.0” and each port address. The generated physical addresses “1.5.0.0”, “1.6.0.0” and “1.7.0.0”, together with the port numbers of the corresponding HDMI input ports, are stored in the address table. Further, the PA process module 39 sets the created physical address “1.5.0.0” in the EDID data corresponding to the HDMI input port 31 ((d) in FIG. 8). Similarly, the PA process module 39 sets the created physical address “1.6.0.0” in the EDID data corresponding to the HDMI input port 32, and sets the created physical address “1.7.0.0” in the EDID data corresponding to the HDMI input port 33.

In FIG. 6, the AMP 501 is connected to the HDMI input port 31 of the source-side wireless transfer apparatus 401. A source device 601 is connected to the HDMI input port 32 of the source-side wireless transfer apparatus 401, and a source device 602 is connected to the HDMI input port 33 of the source-side wireless transfer apparatus 401. The AMP 501 can acquire its own address “1.5.0.0” by reading the EDID data corresponding to the HDMI input port 31. Similarly, the source device 601 can acquire its own address “1.6.0.0” by reading the EDID data corresponding to the HDMI input port 32, and the source device 602 can acquire its own address “1.7.0.0” by reading the EDID data corresponding to the HDMI input port 33.

As has been described above, in the present embodiment, the sink-side wireless transfer apparatus 301 generates the physical addresses, which are to be allocated to the source-side wireless transfer apparatuses, by using only the two upper bits of the four bits of the digit next to the last effective digit of its own physical address. This enables each source-side wireless transfer apparatus to use the two lower bits of the four bits in order to generate physical addresses which are to be allocated to source devices. Thus, the 6-level-deep hierarchy can be managed by the 4-digit PA.

In the present embodiment, the four bits of the second digit of the PA are divided into the upper bit portion and the lower bit portion, and the upper bit portion is used for the allocation of the physical address to each source-side wireless transfer apparatus. However, needless to say, the four bits, which are divided into the upper bit portion and the lower bit portion, are not limited to those of the second digit.

In addition, in the present embodiment, the four bits of the second digit of the PA are divided into the two upper bits and two lower bits. Alternatively, these four bits may be divided into three upper bits and one lower bit, and the three upper bits may be used for the allocation of the physical address to each source-side wireless transfer apparatus and the one lower bit may be used for the allocation of the physical address to each device connected to each source-side wireless transfer apparatus. Besides, the one upper bit may be used for the allocation of the physical address to each source-side wireless transfer apparatus and the three lower bits may be used for the allocation of the physical address to each device connected to each source-side wireless transfer apparatus.

As has been described above, in the embodiments, the sink-side wireless transfer apparatus generates a plurality of different physical addresses corresponding to a plurality of source-side wireless transfer apparatuses, transmits the generated physical addresses to the source-side wireless transfer apparatuses, and manages the generated physical addresses in association with the identifiers of the source-side wireless transfer apparatuses. Therefore, the routing control for changing the active source device can correctly be executed, and wireless data transfer can correctly be executed between each of the plural source-side wireless transfer apparatuses, which are connected by wire to the plural source devices, and the sink device.

In the embodiments, the wired communication interface is exemplified by HDMI. However, each embodiment is applicable to various wired communication interfaces which use physical address management similar to HDMI.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless transfer apparatus comprising:
a wired interface configured to communicate with a sink device via an input port of the sink device;
a wireless communication interface configured to wirelessly communicate with a plurality of source-side wireless transfer apparatuses respectively connected to one or more source devices;
a physical address generator configured to generate physical addresses, which are different among the source-side wireless transfer apparatuses, based on a physical address received from the input port of the sink device via the wired interface, and to wirelessly transmit the generated physical addresses to the source-side wireless transfer apparatuses via the wireless communication interface;
a physical address storing module configured to store the generated physical addresses in association with identifiers of the source-side wireless transfer apparatuses; and
a routing control module configured to transmit content data to the sink device via the wired interface, the content data being wirelessly transmitted from the source-side wireless transfer apparatus corresponding to the identifier which is associated with the physical address comprised in a source change request transmitted from the sink device.

2. The wireless transfer apparatus of claim 1, wherein the physical address generator is configured to generate different physical addresses for the respective source-side wireless transfer apparatuses by changing the value at an uppermost digit of “0” value, the digit being one of respective digits in the physical address received from the sink device, such that changed values are unique to the respective source-side wireless transfer apparatuses.

3. The wireless transfer apparatus of claim 1, wherein the physical address generator is configured to generate different physical addresses for the respective source-side wireless transfer apparatuses by changing the value at an upper bit portion of a plurality of bits which represent an uppermost digit of “0” value, the digit being one of respective digits in the physical address received from the sink device, such that changed values are unique to the respective source-side wireless transfer apparatuses, and
at least one of the source-side wireless transfer apparatuses comprises a first input port and a second input port to which a source device is connectable, and is configured to generate a first physical address and a second physical address corresponding to the first input port and the second input port, respectively, by changing the value at a lower bit portion of a plurality of bits which represent an uppermost digit of “0” value, the digit being one of respective digits in the physical address generated by the physical address generator, such that changed values are unique to the respective input ports.

4. The wireless transfer apparatus of claim 1, further comprising a measuring module configured to measure radio wave intensities of radio signals received from the plurality of source-side wireless transfer apparatuses,
wherein the physical address generator is configured to generate different physical addresses for the respective source-side wireless transfer apparatuses, based on a result of measurement, such that a lowest physical address is allocated to the source-side wireless transfer apparatus with a highest radio wave intensity of all the source-side wireless transfer apparatuses.

5. A wireless transfer method that transfers to a sink device content data wirelessly transmitted from one of a plurality of source-side wireless transfer apparatuses connected to a plurality of source devices respectively by wire, the wireless transfer method comprising:
generating physical addresses, which are different among the source-side wireless transfer apparatuses and are based on a physical address received from the sink device via a wired interface, and wirelessly transmitting the generated physical addresses to the source-side wireless transfer apparatuses;
storing the generated physical addresses in association with identifiers of the source-side wireless transfer apparatuses; and
transmitting content data to the sink device via the wired interface, the content data being wirelessly transmitted from the source-side wireless transfer apparatus corresponding to the identifier which is associated with the physical address included in a source change request transmitted from the sink device.

6. The wireless transfer method of claim 5, wherein the generating generates different physical addresses for the respective source-side wireless transfer apparatuses by changing the value at an uppermost digit of “0” value, the digit being one of respective digits in the physical address received from the sink device, such that changed values are unique to the respective source-side wireless transfer apparatuses.

7. The wireless transfer method of claim 5, wherein the generating generates different physical addresses for the respective source-side wireless transfer apparatuses by changing the value at an upper bit portion of a plurality of bits which represent an uppermost digit of “0” value, the digit being one of respective digits in the physical address received from the sink device, such that changed values are unique to the respective source-side wireless transfer apparatuses, and
at least one of the source-side wireless transfer apparatuses a first input port and a second input port to which a source device is connectable, and is configured to generate a first physical address and a second physical address corresponding to the first input port and the second input port, respectively, by changing the value at a lower bit portion of a plurality of bits which represent an uppermost digit of “0” value, the digit being one of respective digits in the physical address generated by the physical address generator, such that changed values are unique to the respective input ports.

8. The wireless transfer method of claim 5, further comprising measuring radio wave intensities of radio signals transmitted from the source-side wireless transfer apparatuses,
wherein the generating generates different physical addresses for the respective source-side wireless transfer apparatuses, based on a result of measurement, such that a lowest physical address is allocated to the source-side wireless transfer apparatus with a highest radio wave intensity of all the source-side wireless transfer apparatuses.

9. The wireless transfer apparatus of claim 1, wherein the physical address generator is configured to generate different physical addresses for the respective source-side wireless transfer apparatuses by changing the value at an upper bit portion of a plurality of bits which represent an uppermost digit of “0” value, the digit being one of respective digits in the physical address received from the sink device, such that changed values are unique to the respective source-side wireless transfer apparatuses.

10. The wireless transfer method of claim 5, wherein the generating generates different physical addresses for the respective source-side wireless transfer apparatuses by changing the value at an upper bit portion of a plurality of bits which represent an uppermost digit of “0” value, the digit being one of respective digits in the physical address received from the sink device, such that changed values are unique to the respective source-side wireless transfer apparatuses.
